(19) United States
(12) Patent Application Publication
(10) Pub. No.: US 2011/0123260 A1
(43) Pub. Date: May 26, 2011

(54) QUICK-ACTION FASTENING ELEMENT

(75) Inventor: Sven Budde, Luebbecke (DE)

(73) Assignee: PAUL HETTICH GMBH & CO. KG, Kirchlengern (DE)

(21) Appl. No.: 13/054,119

(22) PCT Filed: Jul. 15, 2009
(86) PCT No.: PCT/EP2009/059054

§ 371 Date: Jan. 14, 2011

(30) Foreign Application Priority Data
Jul. 30, 2008 (DE) 20 2008 010 187.5

(51) Int. Cl. F16B 5/06

(52) U.S. Cl. 403/188

(57) ABSTRACT

A quick-action fastening element (10) serves for fastening a guide rail (7) to a rod (5) of a grid-like side part (3), in particular for baking ovens, wherein the rod (5) has an end portion (6) which is bent at an angle relative to the longitudinal direction, and the quick-action fastening element (10) engages with a first clip (11) at least partially around a portion of the rod (5) arranged in the longitudinal direction and engages with a second clip (12) at least partially around the bent end portion (6), wherein a resilient latching element (13) is provided which engages behind the rod (5), wherein the quick-action fastening element (10) has provided on it a stop (15) for limiting the pivoting travel of the latching element (13).

The present invention relates to a quick-action fastening element for fastening a guide rail on a rod of a latticed side part, in particular for ovens, according to the preamble of claim 1.

DE 20 2006 002 251 discloses a quick-action fastening device for fixing a guide rail of a pullout guide on a latticed side part, clamp-like holding sections being provided, which at least partially enclose a rod. Furthermore, locking elements are provided for fixing the quick-action fastening device, which engage behind a rod, so that the guide rail is fixable on the rod by locking. The locking element can be bent manually out of the fastening location in order to remove the quick-action fastening device. It can occur that the locking element does not return completely into the fastening location due to excessive bending and thus loses its functionality. In addition, a risk of injury exists due to the uncontrolled pivoting of the locking element.

A quick-action fastening element is known from DE 20 2005 020 458, which is implemented for fixing a pullout guide on a rod, the rod being enclosed both in the longitudinal direction and also on a bent-over end section. Locking means, which engage behind a rod in a springy manner, are also provided here for securing the quick-action fastening elements. When the locking means are disengaged for removal, the danger also exists here of permanent bending, and therefore a secure hold is not ensured in the event of reinstallation because of this.

It is therefore the object of the present invention to provide a quick-action fastening element, which remedies the mentioned disadvantages and allows simple installation and removal of a guide rail on or from a rod of a latticed side part.

This object is achieved by a quick-action fastening element having the features of claim 1.

According to the invention, a stop is provided on the quick-action fastening element for limiting the pivot distance of the locking element, so that excessive bending and exceeding the elastic spring range of the quick-action fastening element connected thereto can be reliably prevented. The locking element is implemented so it is only pivotable by a predetermined pathway, so that secure handling is ensured. In addition, the risk of injury can also be minimized by the formation of a stop.

According to a preferred embodiment of the invention, the stop is situated so that the locking element is pivotable in a springy manner in an elastic range. Therefore, the user does not have to consider how far the locking element may be pivoted. The locking element can be integrally formed with the quick-action fastening element, but a formation as a separate component is also possible. The stop is preferably implemented as a web which is integrally formed with the first or second clamp. The production is thus simplified, since the quick-action fastening element can be produced from a metal plate as a simple stamped and bent part.

In order to prevent pulling off of the quick-action fastening element in a direction parallel to the bent-over end section of the rod, a projection which engages behind the rod can be formed on the locking element.

In order to allow simple actuation of the locking element, a projection can be formed thereon which engages through the opening on the first or second clamp. This projection can be used as a handle section, the maximum distance for pivoting the locking element being predefined by the length of the opening when the locking element is pivoted using the projection. The actuation of the locking element via the projection can thus also be displaced to an inner side on a side part of an oven, i.e., the user no longer has to engage in the gap between quick-action fastening element and side wall of the oven.

For simple installation of the locking element, a handle section can be formed, which simplifies the positioning of the quick-action fastening element. The handle section can additionally be provided with a handle element produced from high-temperature-resistant plastic.

The latticed side part is advantageously to be taken out of the oven before the removal of the pullout guides in the case of rods pressing closely against the side wall.

The use of a quick-action fastening element according to the invention is sufficient to fix the pullout guide on the latticed side part. On the side opposite to the quick-action fastening element in the pullout direction, it is sufficient to use an element which encloses the rod.

The invention is explained in greater detail hereafter on the basis of multiple exemplary embodiments with reference to the appended drawings. In the figures:

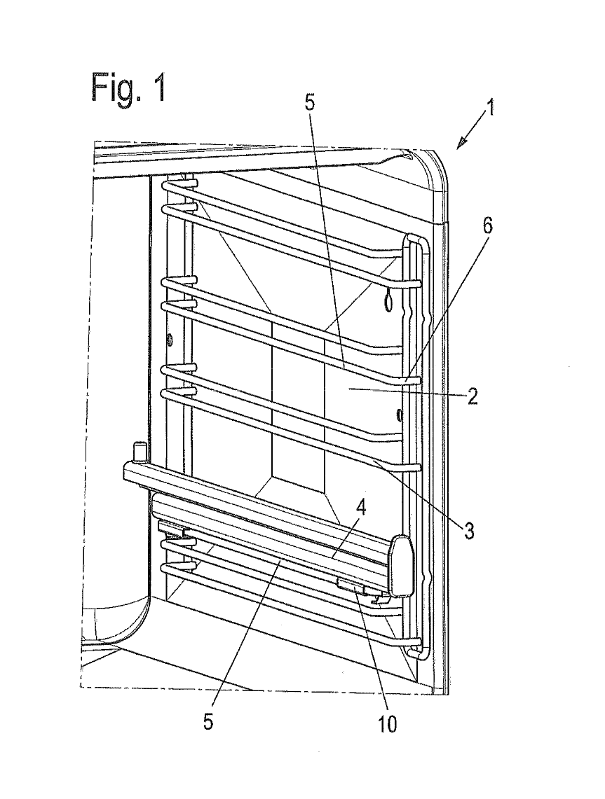

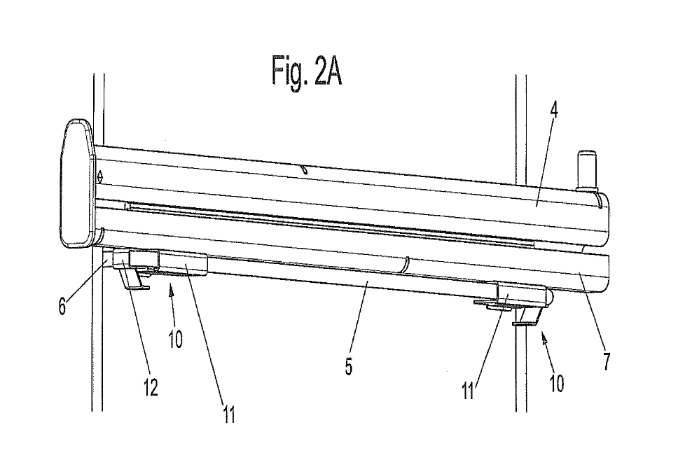

FIG. 1 shows a perspective view of a side wall of an oven having a side part, on which a quick-action fastening element is installed;

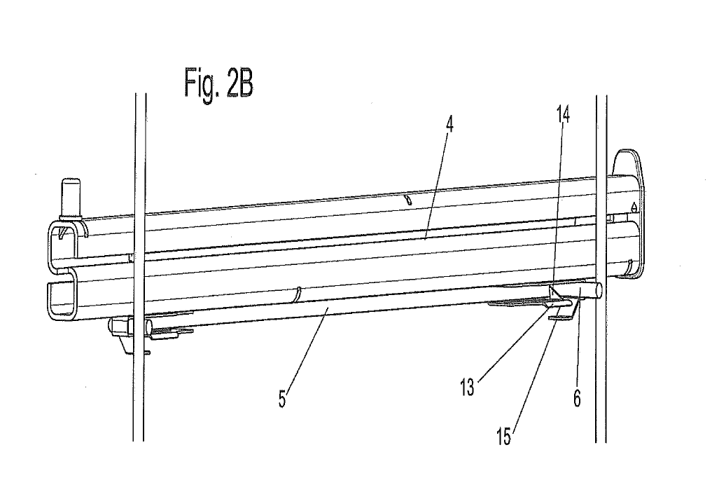

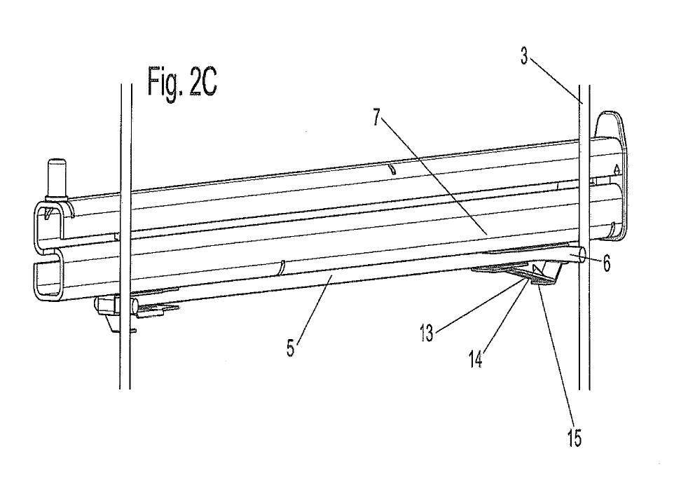

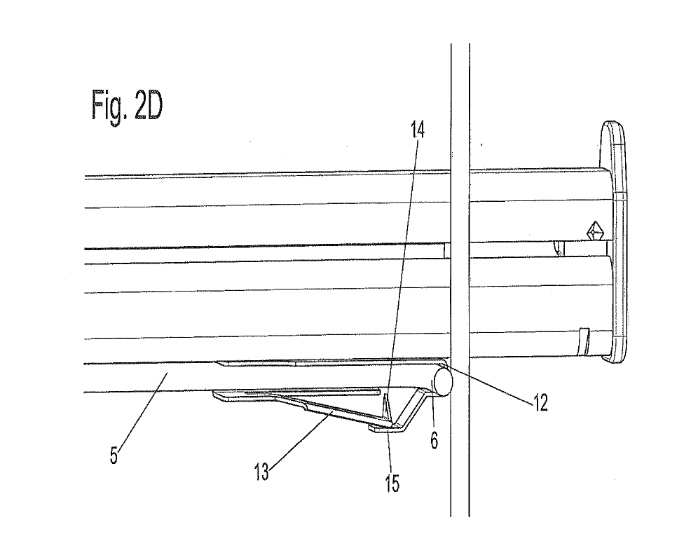

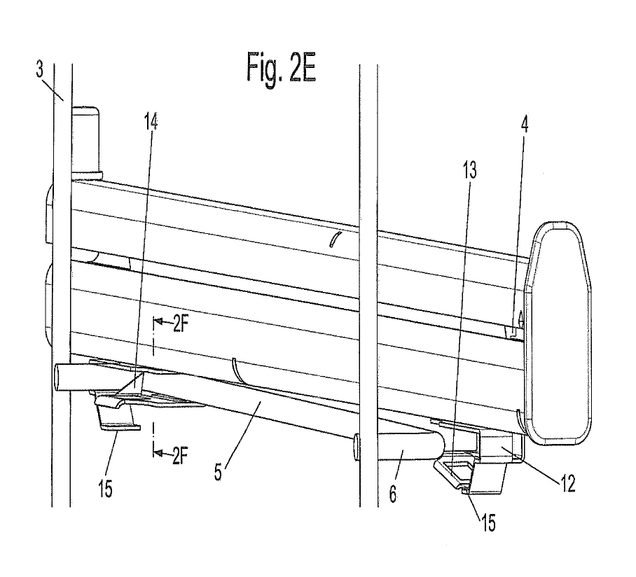

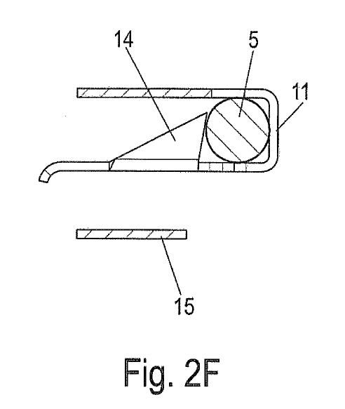

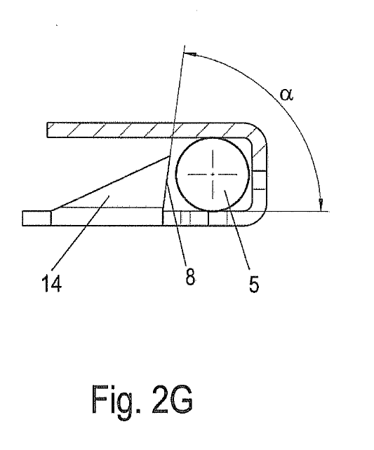

FIGS. 2A to 2G show several views of a quick-action fastening element according to the invention during the installation on a side part;

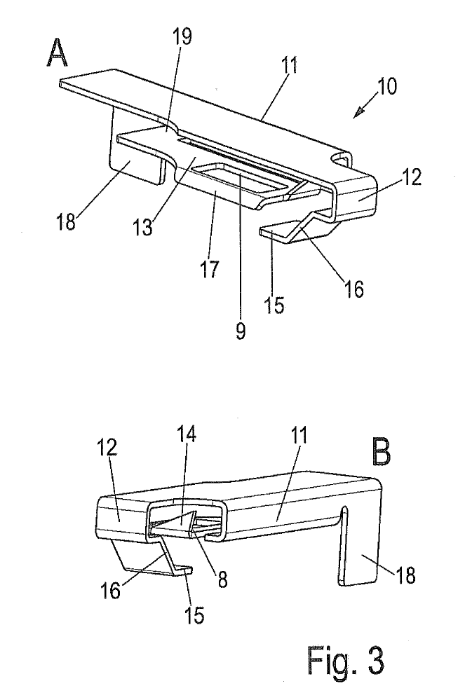

FIGS. 3A to 11B show several views of different embodiments of quick-action fastening elements.

A latticed side part 3, on which baking sheets, grills, or other food carriers may be laid or inserted, is fixed on a side wall 2 of an oven 1. A pullout guide 4, which is fixed via two quick-action fastening elements 10 according to the invention, is provided on at least one rod 5 of the side part 3.

As is recognizable in the detail view of FIGS. 2A and 2B, two quick-action fastening elements 10 are fixed on a rod 5, the rod 5 having a bent-over end section 6 on each end. Each fastening element 10 encloses the rod 5 essentially in a U shape using a first clamp 11. A second clamp 12 of the quick-action fastening element 10 is provided on the bent-over end section 6, which encloses it essentially in a U shape. In order to secure the quick-action fastening element 10 on the rod 5, a locking element 13 is provided in the form of a pivotable locking tongue, on which an upwardly protruding projection 14 is formed. The projection 14 prevents the quick-action fastening element 10 from being able to be pulled off in the horizontal plane of the bent-over end section 6. The projection 14 forms an obtuse angle a, preferably between 75° and 88°, between a contact edge 8 adjacent to the rod 5 and the horizontal, in order to ensure secure contact of the rod 5.

Furthermore, a stop 15 is provided on the quick-action fastening element 10, which is situated spaced apart from the pivotable locking element 13 and delimits the pivot pathway of the locking element 13.

A position of a locking element 13, into which it was pivoted downward manually or by a tool until it presses against the stop 15, is shown in FIGS. 2C and 2D. In the downwardly-pivoted position, the upwardly protruding projection 14 is below the rod 5, so that the quick-action fastening element 10 can be removed from the rod 5 in the horizontal plane of the bent-over end section 6.

As shown in FIG. 2E, the pullout guide 4 can be taken off of the latticed side part 3 by the successive disengagement of both quick-action fastening elements 10.

The quick-action fastening element 10 is shown in detail in FIGS. 3A and 3B. The springy locking element 13 is connected via a web 19 to the first clamp 11, which encloses the rod 5 in a U shape. A web 16, which is situated at an angle to the horizontal and forms the stop 15 at one end, is formed on the second clamp 12, which encloses the bent-over end section 6 in a U shape. Furthermore, an angled handle strip 17 is provided on the locking element 13, which stiffens the section from the elastic bending area up to the locking projection 14 and makes handling easier. In order to also allow the installation of the quick-action fastening element 10 on the lateral surface of the pullout guide, a plate-shaped fastening section 18 is formed on the first clamp 11, which protrudes downward and is used for the optional lateral fixing on the pullout guide 4.

A rectangular recess 9 in the locking element 13 allows the extensibility for a welding device, to connect the locking element 13 to the pullout guide by welding. In addition, it can be used to receive a separate handle part (not shown).

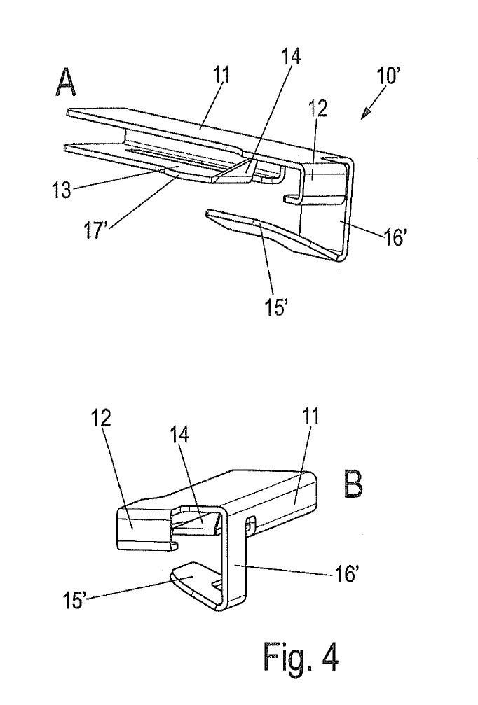

FIGS. 4A and 4B show a second embodiment of a quick-action fastening element 10′ according to the invention, in which, in contrast to the first exemplary embodiment, a stop 15′ is not formed integrally with the second clamp 12, but rather with the first clamp 11. For this purpose, a web 16′ extends downward from the clamp 11 and carries the stop 15′. Furthermore, instead of the angled handle strip, a widened protruding area 17′ is provided as the handle section on the locking element 13. The stop 15′ is not situated parallel to the plane of the rod 5 here, so that only the front edge of 15′ delimits the pivot pathway of the locking element 13.

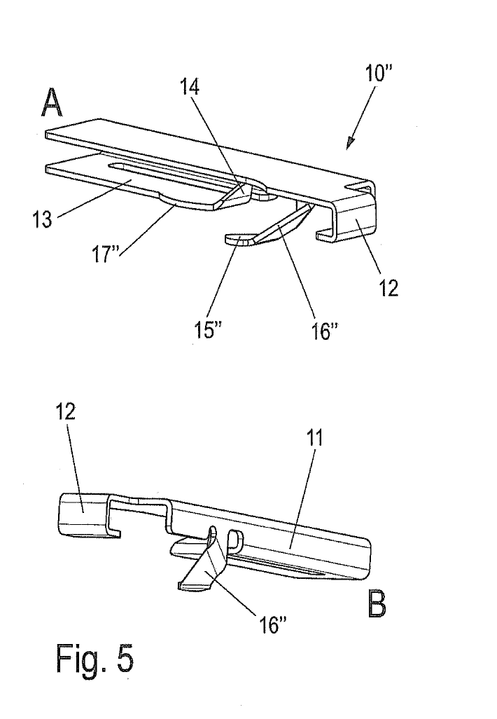

In the exemplary embodiment shown in FIGS. 5A and 5B, a stop 15″ is provided on the quick-action fastening element 10″, which is formed integrally with the clamp 11. The stop 15″ is situated inside the clamp 11 and is therefore additionally connected to the clamp 11 via a twisted web 16″, in order to also protrude as little as possible into the cooking space.

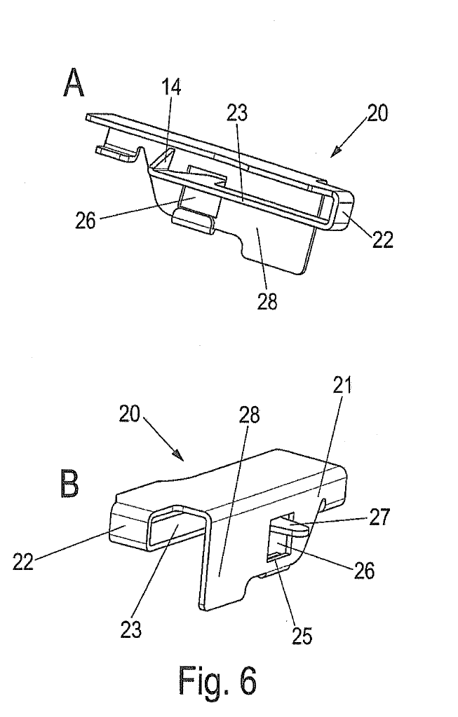

An embodiment of a quick-action fastening element 20 is shown in FIGS. 6A and 6B, in which a first clamp 21 having U-shaped cross-section and a second clamp 22 having

U-shaped cross-section are formed for fixing on the rod. A web-shaped locking element 23 is integrally formed with the second clamp 22, on which an upwardly directed projection 24 is shaped, which rests adjacent to the rod 5. Furthermore, a lateral projection 27 is formed on the fastening element 23, which engages through an opening 26, which is situated on a downwardly directed plate 28. The opening 26 is formed as an oblong hole and the lower edge 25 of the opening 26 is used as a stop. A handle section 27 protrudes through the opening 26, which simplifies the actuation of the locking element 23. With respect to the installation situation on a side part 3, for example, in an oven, the actuation of the locking element 23 can be performed from the side toward the middle of the cooking space, and the user no longer has to engage between a side wall 2 of the oven and the pullout guide 4, or take the latticed side part out of the oven, depending on the embodiment of the latticed side part. The plate 28 conceals the rod 5 extending up to the end section 6.

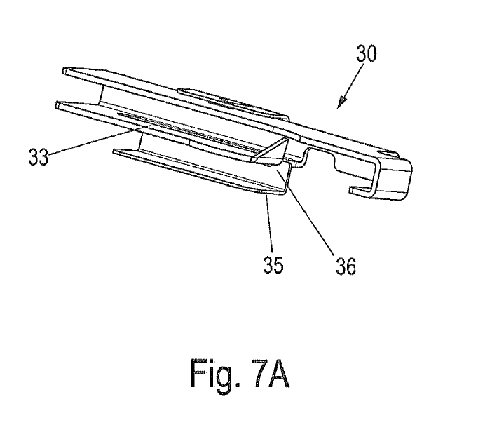

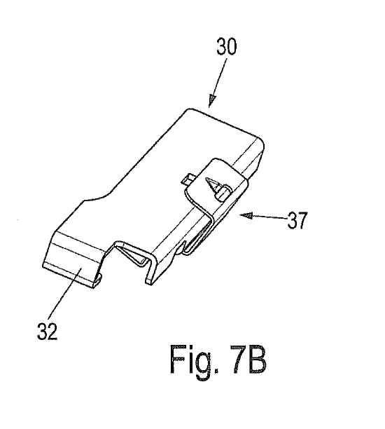

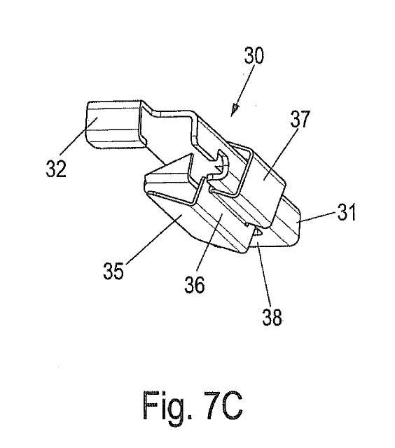

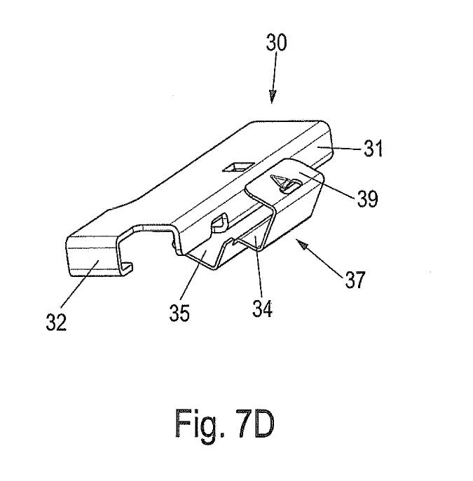

A further embodiment of a quick-action fastening element 30 is shown in FIGS. 7A to 7D, which again has a first clamp 31 for fixing on the rod 5 and a second clamp 32 for fixing on the bent-over end section 6. A web-shaped locking element 33 is connected via a connection web 38 on one side to the clamp 31. A stop 35 is provided below the locking element 33, which is not formed integrally with one of the clamps 31 or 32, however, but rather is provided by a component which can be plugged on separately. The stop 35 is connected via a wall 36 to a holding element 37, which encloses the first clamp 31. The holding element 37 can be snapped on the clamp 31 via the legs 34, 39. Other types of fastening may also be used, for example, gluing or welding.

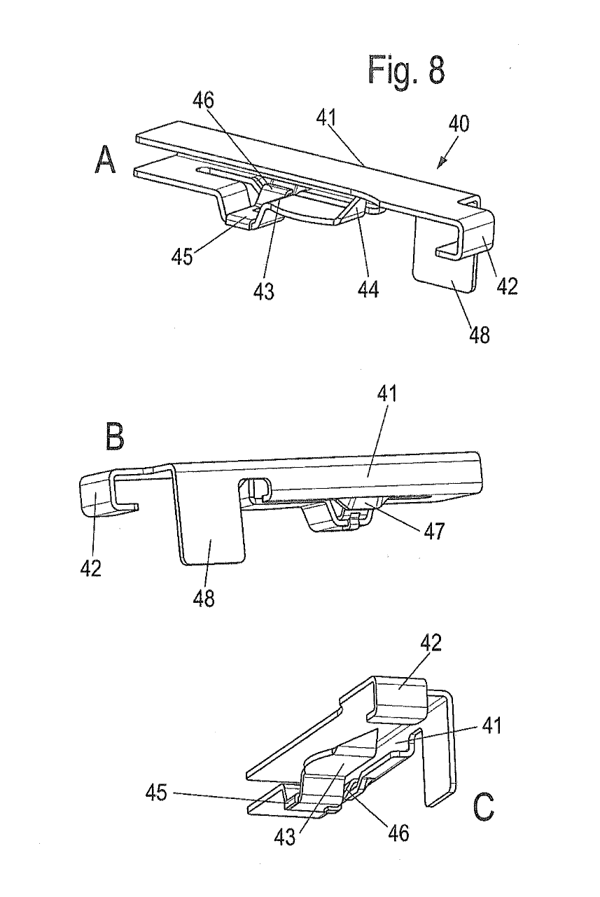

A further embodiment of a quick-action fastening element 40 is shown in FIGS. 8A to 8C, in which a first clamp 41 is provided for enclosing a rod 5 and a second clamp 42 is provided for enclosing a bent end section 6. A movable locking element 43 is formed on the quick-action fastening element 40, on which an upwardly directed projection 44 is shaped. In a middle area of the locking element 43, a depression is formed, into which a clip 45 is pushed. The clip 45 forms a stop with an end section 46, which is insertable into a depression 47 on the clamp 41. The clip 45 can also be integrally formed with the fastening element 43. During pivoting of the locking element 43, the stop 46 strikes against the depression 47, so that the maximum pivoting pathway is limited. Furthermore, a plate-shaped fastening section 48 is also formed on the first clamp 41, which is used for the optional lateral fixing on the pullout guide 4.

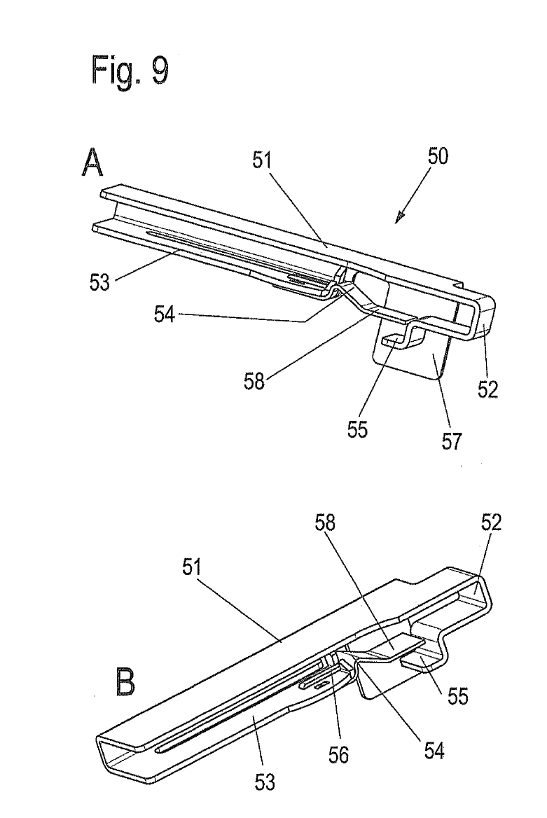

A further embodiment of a quick-action fastening element 50 is shown in FIGS. 9A and 9B, which comprises a first clamp 51 and a second clamp 52. Furthermore, a web-shaped locking element 53 is provided, on which a separate end section 58 is fastened, which reaches up to a stop 55, which is integrally formed with the second clamp 52. In this exemplary embodiment, the upwardly directed projection is not formed terminally on the locking element 53 but rather in a middle area. A step 54 is produced by bending the web of the locking element 53. A fastening web 56 is provided to produce the connection to the locking element 53. A plate-shaped fastening section 57 is also provided adjacent to the first clamp 51, which is used for the optional lateral fixing on the pullout guide 4.

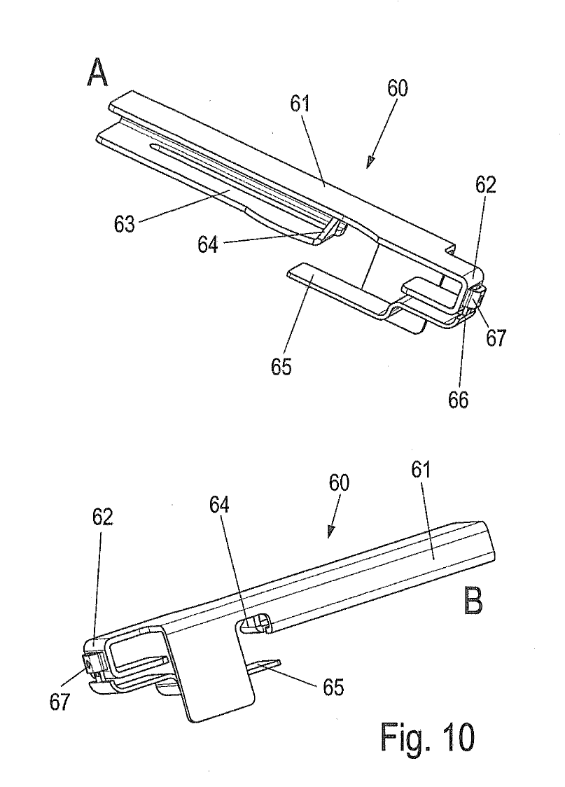

In the exemplary embodiment shown in FIGS. 10A and 10B, a quick-action fastening element 60 is provided, in which a first clamp 61 and a second clamp 62 are provided. To form a stop 65 for a locking element 63, a U-shaped receptacle 67 is formed on the second clamp 62, into which a web 66 is inserted. The web 66 is integrally formed with the stop 65.

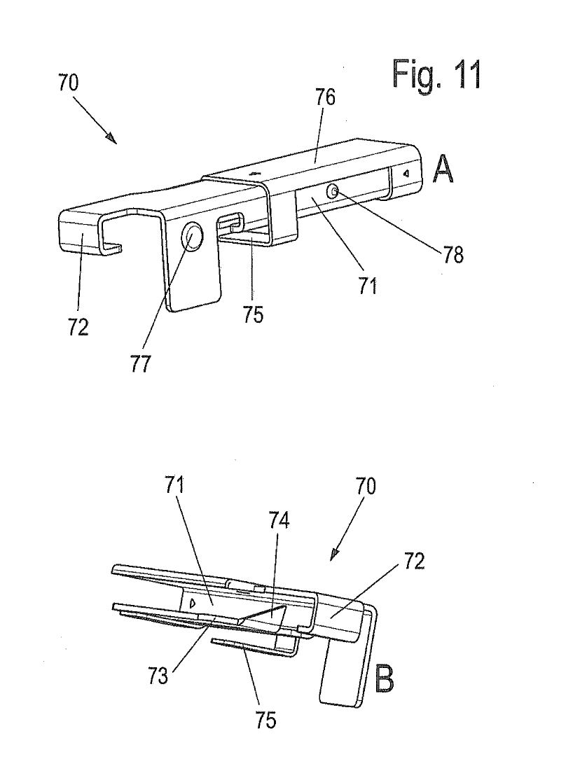

In the quick-action fastening element 70 shown in FIGS. 11A and 11B, a first clamp 71 is provided for fixing on the rod 5 and a second clamp 72 is provided for fixing on the bent-over end section 6. To form a stop 75, a holding element 76 is provided, which encloses the first clamp 71. The sliding element 76 can also be fixed on the first clamp 71 by clamping, gluing, or other fastening means. The stop 75 is provided at a distance below a locking element 73, which has an upwardly directed projection 74, which is situated adjacent to the rod 5 in the installed position.

Furthermore, two studs 77 and 78 are provided on the quick-action fastening element 70, which are produced raised as connection points to the pullout guide 4 according to the material thickness of the sliding element 76.

The quick-action fastening elements shown may be produced from a stamped and bent metal plate, but an implementation entirely or partially from various metals or from plastic is also possible. A guide rail can be fixed on the quick-action fastening element by welding or gluing or other fastening means on the bottom side or laterally facing away from the middle of the cooking chamber.

### LIST OF REFERENCE NUMERALS

1 oven

2 side wall

3 latticed side part

4 pullout guide

5 rod

6 end section

7 guide rail

8 contact edge

9 rectangular hole

10 quick-action fastening element

10′ quick-action fastening element

10″ quick-action fastening element

11 first clamp

12 second clamp

13 locking element

14 projection

15 stop

15′ stop

15″ stop

16 web

16′ web

16″ web

17 handle strip

17′ handle strip

18 fastening section

19 web

20 quick-action fastening element

21 first clamp

22 second clamp

23 locking element

24 projection

25 edge

26 opening

27 projection/handle section

28 plate

30 quick-action fastening element

31 first clamp

32 second clamp

33 web-shaped locking element

34 leg

35 stop

36 wall

37 holding element

38 connection web

39 leg

40 quick-action fastening element

41 first clamp

42 second clamp

43 locking element

44 projection

45 clip

46 stop

47 depression

48 fastening section

50 quick-action fastening element

51 first clamp

52 second clamp

53 web-shaped locking element

54 step

55 stop

56 fastening web

57 plate-shaped fastening section

58 end section

60 quick-action fastening element

61 first clamp

62 second clamp

63 locking element

65 stop

66 web

67 receptacle

70 quick-action fastening element

71 first clamp

72 second clamp

73 locking element

74 projection

75 stop

76 holding element

77 stud

78 stud

1. A quick-action fastening element (10, 10′, 10″, 20, 30, 40, 50, 60, 70) for fastening a guide rail (7) on a rod (5) of a latticed side part (3), in particular for ovens, the rod (5) having an end section (6) bent over at an angle to a longitudinal direction, and the quick-action fastening element (10, 10′, 10″, 20, 30, 40, 50, 60, 70) at least partially enclosing a section of the rod (5) situated in the longitudinal direction using a first clamp (11, 21, 31, 41, 51, 61, 71) and at least partially enclosing the bent-over end section (6) using a second clamp (12, 22, 32, 42, 52, 62, 72), a springy locking element (13, 23, 33, 43, 53, 63, 73) being provided, which engages behind the rod (5), characterized in that a stop (15, 25, 35, 45, 55, 65, 75) is provided on the quick-action fastening element (10, 20, 30, 40, 50, 60, 70) to limit the pivot pathway of the locking element (13, 23, 33, 43, 53, 63, 73).

2. The quick-action fastening element according to claim 1, characterized in that the stop (15, 25, 35, 45, 55, 65, 75) is situated so that the locking element (13, 23, 33, 43, 53, 63, 73) is pivotable in a springy manner in an elastic range.

3. The quick-action fastening element according to claim 1, characterized in that the stop (15, 25, 35, 45, 55) is integrally formed with the quick-action fastening element.

4. The quick-action fastening element according to claim 1, characterized in that the stop (15, 25, 35, 45, 55, 65) is formed as a web which is shaped integrally with the first or second clamp (11, 12).

5. The quick-action fastening element according to claim 1, characterized in that the stop (15, 25, 35, 45, 55, 65, 75) is formed as a web, which is positioned at a distance from the locking element (13, 23, 33, 43, 53, 63, 73).

6. The quick-action fastening element according to claim 1, characterized in that the locking element (13, 23, 33, 43, 53, 63, 73) is formed as a springy locking tongue having a terminal projection (14, 24, 34, 44, 54, 64, 74).

7. The quick-action fastening element according to claim 1, characterized in that the pivot axis of the locking element (13, 23, 33, 43, 53, 63, 73) is situated parallel to the bent-over end section (6).

8. The quick-action fastening element according to claim 1, characterized in that a projection (27) is formed on the locking element (23), which engages through an opening (26) on the first or second clamp (21, 22).

9. The quick-action fastening element according to claim 8, characterized in that the opening (26) is formed as an oblong hole and the projection (27) is movable within the opening (26).

10. The quick-action fastening element according to claim 1, characterized in that the stop is fixed as a separate component on one of the clamps (31, 32; 61, 62).

11. The quick-action fastening element according to claim 10, characterized in that the stop (35, 36) is fixed by locking or clamping on the first or second clamp.

12. The quick-action fastening element according to claim 1, characterized in that a handle section (17, 17′, 27) is formed on the locking element (13, 23, 33, 43, 53, 63, 73).

13. The quick-action fastening element according to claim 1, characterized in that the fastening element is produced from a stamped and bent metal plate.
